(19) United States
(12) Patent Application Publication
(10) Pub. No.: US 2024/0071226 A1
(43) Pub. Date: Feb. 29, 2024

(54) PARKING MANAGEMENT DEVICE, PARKING MANAGEMENT METHOD, AND PARKING MANAGEMENT COMPUTER PROGRAM FOR MANAGING PARKING

(71) Applicant: TOYOTA JIDOSHA KABUSHIKI KAISHA, Toyota-shi Aichi-ken (JP)

(72) Inventor: Kazuma Fukumoto, Taiotou-ku Tokyo-to (JP)

(73) Assignee: TOYOTA JIDOSHA KABUSHIKI KAISHA, Toyota-shi Aichi-ken (JP)

(21) Appl. No.: 18/234,947

(22) Filed: Aug. 17, 2023

(30) Foreign Application Priority Data
Aug. 23, 2022 (JP) 2022-132373

(51) Int. Cl. G08G 1/14

(52) U.S. Cl. CPC G08G 1/143; G08G 1/145

(57) ABSTRACT

A parking management device includes a memory configured to store the shape and size of a predetermined parking area; and a processor configured to determine parking positions of a plurality of vehicles requesting parking in the parking area, based on the shape and size of the parking area and outline information of each of the vehicles, and notify each of the vehicles of a parking position determined for the vehicle via a communication interface.

### CROSS-REFERENCE TO RELATED APPLICATION

This application claims priority to Japanese Patent Application No. 2022-132373 filed on Aug. 23, 2022, the entire contents of which are herein incorporated by reference.

### FIELD

The present disclosure relates to a parking management device, a parking management method, and a parking management computer program for determining parking positions of vehicles to be parked in a parking lot.

### BACKGROUND

Some parking lots do not have lines indicating individual parking spaces. In such a parking lot, vehicles are parked in order of arrival with appropriate distance therebetween so as not to come into contact with a parked vehicle. This makes it difficult to park vehicles so as to make efficient use of parking space of the parking lot. In view of this, a technique to set parking spaces appropriately has been proposed (see International Publication WO2017/104164A).

A method for supporting parking disclosed in WO2017/104164A sets a virtual parking slot group including a plurality of virtual parking slots, aligns the virtual parking slot group with respect to the recognized parked vehicles, and determines the aligned virtual parking slot group as a parking slot group including a plurality of parking slots.

### SUMMARY

Unfortunately, the above-described technique may fail to set parking spaces without wasting space, depending on the distance between parked vehicles, because the group of parking spaces is set on the basis of parked vehicles.

It is an object of the present disclosure to provide a parking management device that can determine parking positions of vehicles without wasting space in a parking area.

According to an embodiment, a parking management device is provided. The parking management device includes a memory configured to store a shape and size of a predetermined parking area; and a processor configured to determine parking positions of a plurality of vehicles requesting parking in the parking area, based on the shape and size of the parking area and outline information of each of the vehicles, and notify each of the vehicles of a parking position determined for the vehicle via a communication interface.

In some embodiments, the processor of the parking management device determines a parking position and an expected time of entering the parking area for each of the vehicles in accordance with a best-fit algorithm after receiving requests for parking from the vehicles, and notifies each of the vehicles of the expected time of entering and the parking position of the vehicle via the communication interface.

Alternatively, in some embodiments, every time one of the vehicles arrives at the parking area, the processor of the parking management device determines a parking position of the arrived vehicle in accordance with a bottom-left algorithm.

In some embodiments, the processor is further configured to divide the parking area into a plurality of divisions, assign each of the vehicles one of the divisions, and determine, for each of the divisions, parking positions of one or more vehicles assigned the division among the plurality of vehicles, based on the outline information of the one or more vehicles and a shape and size of the division.

In some embodiments, the processor divides the parking area into the divisions so as to provide each of the divisions with a passage space that enables the one or more vehicles to pass from the division to an entrance of the parking area.

In some embodiments, the processor sets the passage space so that the passage space of at least one of the divisions overlaps another of the divisions.

According to another embodiment, a parking management method is provided. The method includes determining parking positions of a plurality of vehicles requesting parking in a predetermined parking area, based on a shape and size of the parking area and outline information indicating a shape and size of each of the vehicles; and notifying each of the vehicles of a parking position determined for the vehicle via a communication interface.

According to still another embodiment, a non-transitory recording medium that stores a parking management computer program is provided. The computer program includes instructions causing a computer to execute a process including determining parking positions of a plurality of vehicles requesting parking in a predetermined parking area, based on a shape and size of the parking area and outline information indicating a shape and size of each of the vehicles; and notifying each of the vehicles of a parking position determined for the vehicle via a communication interface.

The parking management device according to the present disclosure has an effect of being able to determine parking positions of vehicles without wasting space in a parking area.

### BRIEF DESCRIPTION OF DRAWINGS

FIG. 1 schematically illustrates the configuration of a parking management system equipped with a parking management device.

FIG. 2 illustrates the hardware configuration of a server, which is an example of the parking management device.

FIG. 3 is a functional block diagram of a processor of the server, related to a parking management process.

FIG. 4 illustrates the sequence of the parking management process executed between each vehicle to be parked and the server when the entering order and the leaving order of vehicles to be parked are fixed.

FIG. 5 illustrates the sequence of the parking management process executed between each vehicle to be parked and the server when the leaving order of vehicles to be parked is fixed and the entering order of the vehicles is not restricted.

FIG. 6 is a schematic diagram for explaining determination of parking positions of vehicles according to a modified example.

### DESCRIPTION OF EMBODIMENTS

A parking management device, a method for managing parking executed by the parking management device, and a computer program for managing parking will now be described with reference to the attached drawings. The parking management device determines parking positions of vehicles requesting parking in a parking area to be managed, based on the shape and size of the parking area and outline information indicating the shape and size of each vehicle, and notifies each vehicle of the determined parking position.

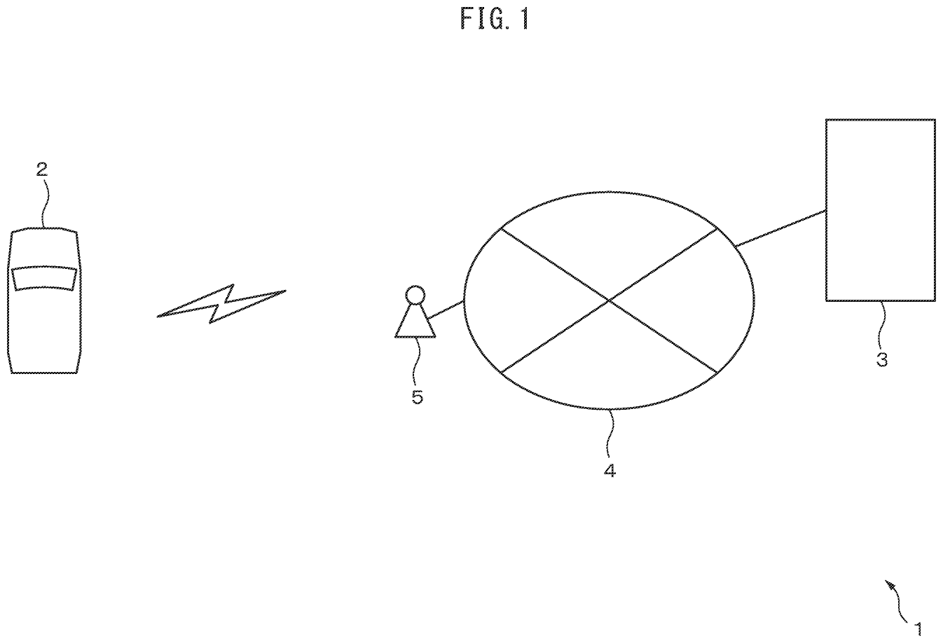

FIG. 1 schematically illustrates the configuration of a parking management system equipped with a parking management device. In the present embodiment, the parking management system 1 includes multiple vehicles 2 and a server 3, which is an example of the parking management device. For example, each vehicle 2 accesses a wireless base station 5, which is connected via a gateway (not illustrated) to a communication network 4 connected with the server 3, thereby connecting to the server 3 via the wireless base station 5 and the communication network 4. For simplicity, FIG. 1 illustrates only a single vehicle 2. FIG. 1 also illustrates only a single wireless base station 5, but the communication network 4 may be connected with multiple wireless base stations 5.

For example, each of the vehicles 2, to which autonomous driving control is applicable, includes a wireless communication terminal, a camera, a GPS receiver, and an electronic control unit (ECU). Each of the vehicles 2 may further include a range sensor, such as LiDAR, radar, or sonar. Of the vehicles 2, a vehicle 2 wishing to be parked in a parking area of a parking lot managed by the server 3 transmits a parking request signal to the server 3 via the wireless base station 5 and the communication network 4, using a wireless communication terminal included in the vehicle 2. The vehicle 2 that has transmitted a parking request signal receives a parking position notification signal from the server 3 via the communication network 4 and the wireless base station 5. The ECU of the vehicle 2 that has received a parking position notification signal parks the vehicle 2 at a parking position indicated by the parking position notification signal, by referring to at least one of the following: images representing the surroundings of the vehicle obtained by a camera, ranging signals obtained by a range sensor, and the current position of the vehicle 2 determined by a GPS receiver. Some of the vehicles 2 may be manually driven by a driver. In this case, the wireless communication terminal of a manually driven vehicle 2 may be a portable communication terminal possessed by a driver, such as a “smartphone.” In this case, a parking position indicated by a received parking position notification signal is displayed on a display included in the wireless communication terminal or a display connected to the wireless communication terminal by wire or wirelessly. The driver refers to the displayed parking position and parks the vehicle 2 at the parking position by manual driving.

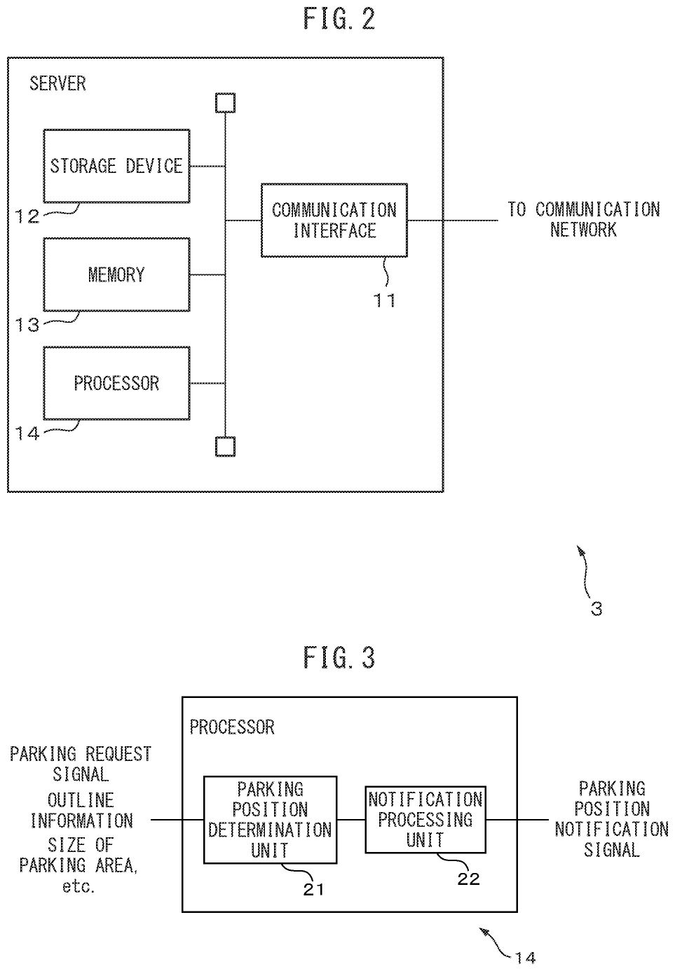

FIG. 2 illustrates the hardware configuration of the server 3, which is an example of the parking management device. The server 3 includes a communication interface 11, a storage device 12, a memory 13, and a processor 14. The communication interface 11, the storage device 12, and the memory 13 are connected to the processor 14 via a signal line. The server 3 may further include an input device (not illustrated), such as a keyboard and a mouse, and a display device (not illustrated), such as a liquid crystal display.

The communication interface 11, which is an example of the communication unit, includes an interface circuit for connecting the server 3 to the communication network 4. The communication interface 11 is configured to be communicable with each of the vehicles 2 via the communication network 4 and the wireless base station 5. More specifically, every time a parking request signal is received from one of the vehicles 2 via the wireless base station 5 and the communication network 4, the communication interface 11 passes the received parking request signal to the processor 14. Further, the communication interface 11 transmits a parking position notification signal received from the processor 14 to each vehicle 2 that has transmitted a parking request signal, via the communication network 4 and the wireless base station 5.

The storage device 12, which is an example of the storage unit, includes, for example, a hard disk drive, or an optical medium and an access device therefor. The storage device 12 stores various types of data and information used in a parking management process. For example, for each of the vehicles 2, the storage device 12 stores outline information indicating the outer shape and size of the vehicle (e.g., information indicating the combination of the full length and full width) in association with identifying information of the vehicle. In addition, the storage device 12 stores the shape, size, and position of a parking area of a parking lot managed by the server 3. The storage device 12 may further store a computer program for the parking management process executed by the processor 14.

The memory 13, which is another example of the storage unit, includes, for example, nonvolatile and volatile semiconductor memories. The memory 13 temporarily stores various types of data generated during execution of the parking management process.

The processor 14 includes one or more central processing units (CPUs) and a peripheral circuit thereof. The processor 14 may further include another operating circuit, such as a logic-arithmetic unit or an arithmetic unit. The processor 14 executes the parking management process.

FIG. 3 is a functional block diagram of the processor 14, related to the parking management process. The processor 14 includes a parking position determination unit 21 and a notification processing unit 22. These units included in the processor 14 are functional modules, for example, implemented by a computer program executed by the processor 14, or may be dedicated operating circuits provided in the processor 14.

The parking position determination unit 21 determines parking positions of vehicles that have transmitted a parking request signal among the vehicles 2, based on outline information of the vehicles that have transmitted a parking request signal and the shape and size of a parking area of a parking lot managed by the server 3. In the following, a vehicle that has transmitted a parking request signal will be referred to as a “vehicle to be parked” for convenience of description.

In the present embodiment, the parking position determination unit 21 determines parking positions of the vehicles to be parked, in accordance with a solution to a “rectangle packing problem.” More specifically, the parking position determination unit 21 determines parking positions of the vehicles to be parked, in accordance with a solution depending on which of the following two conditions is applied.

(Condition 1) The entering order (expected entering times) and the leaving order (expected leaving times) of vehicles to be parked are fixed.

(Condition 2) The entering order (expected entering times) of vehicles to be parked is arbitrary, and the leaving order (expected leaving times) thereof is fixed.

Fixing the leaving order of vehicles to be parked as stated in conditions 1 and 2 eliminates the need for the parking position determination unit 21 to take account of a space where each vehicle to be parked turns and passes to leave the parking area after parking. This enables the server 3 to park more vehicles in the parking area.

Condition 1 is applied, for example, in the case where reservations for parking are taken in advance from people who wish to come, by car, to a facility or a venue related to or located near a parking lot managed by the server 3, in particular, where an event whose start time and end time are fixed in advance is held at such a facility or venue. Thus, vehicles to be parked are those of the vehicles 2 which have transmitted a parking request signal received by the server 3 in a preset application period.

Condition 2 is applied, for example, in the case where vehicles come to a facility or a venue related to or located near a parking lot managed by the server 3 at arbitrary times. Thus, vehicles to be parked are those of the vehicles 2 which have reached the entrance of a parking area of a parking lot managed by the server 3 or a location within a predetermined distance of the entrance and which have transmitted a parking request signal.

Which of conditions 1 and 2 is applied is preset via an input device provided for the server 3 or via another device connected to the server 3 via the communication network 4. In the case where multiple parking lots are managed by the server 3, which of conditions 1 and 2 is applied may be preset for each parking lot.

When condition 1 is applied, the parking position determination unit 21 identifies individual vehicles to be parked that have transmitted a parking request signal, by referring to identifying information of a vehicle included in each parking request signal received in an application period. The identifying information of a vehicle may be, for example, a vehicle identification number (VIN).

For each parking request signal received in the application period, the parking position determination unit 21 reads outline information corresponding to identifying information of a vehicle included in the parking request signal, from the storage device 12. In addition, the parking position determination unit 21 reads information indicating the shape and size of a parking area of a parking lot managed by the server 3 from the storage device 12. The parking position determination unit 21 then determines parking positions of the vehicles to be parked, in accordance with a best-fit algorithm. To this end, the parking position determination unit 21 may use any of various best-fit algorithms. The parking position of each vehicle to be parked is expressed as a rectangular region indicating a space where the vehicle is to be parked. This enables the parking position determination unit 21 to determine parking positions of the vehicles to be parked without wasting space in the parking area. In some embodiments, the parking position determination unit 21 determines the parking position of each vehicle to be parked so that a space necessary for occupants to get on and off can be left between adjacent parked vehicles. To achieve this, the parking position determination unit 21 expands the outer shape of each vehicle to be parked, which is specified by outline information, by a predetermined offset, and uses the expanded shape at application of the best-fit algorithm. In the case where occupants of each vehicle to be parked get off near the entrance of the parking area and where each vehicle to be parked is autonomously driven in the parking area, the parking position determination unit 21 may determine the parking position of each vehicle to be parked so as to reduce the distance between adjacent parked vehicles. Thus, in some embodiments, the parking position determination unit 21 sets the predetermined offset at a smaller value. In this way, the parking position determination unit 21 can increase the number of vehicles that can be parked in the parking area.

Upon determining parking positions of the vehicles to be parked, the parking position determination unit 21 determines the order in which the vehicles to be parked enter the parking area, based on these parking positions and the position of the entrance of the parking area. For example, the parking position determination unit 21 determines the entering order of the vehicles to be parked so that a vehicle to be parked whose parking position is set farther from the entrance of the parking area enters earlier. Specifically, the parking position determination unit 21 determines the entering order so that a vehicle of interest can reach the parking position of the vehicle of interest from the entrance on the assumption that vehicles to be parked that have entered earlier than the vehicle of interest are parked at their parking positions.

In addition, the parking position determination unit 21 determines expected entering times of the vehicles to be parked so that a lower-numbered vehicle in the entering order is assigned an earlier expected entering time. In some embodiments, the parking position determination unit 21 determines the expected entering times of the vehicles to be parked so that all of the vehicles can be parked a predetermined time before the start time of an event held at a facility or venue related to the parking lot. In some embodiments, the parking position determination unit 21 determines the expected entering times of the vehicles to be parked so that the difference between the expected entering times of two successive vehicles to be parked in the entering order is a predetermined time difference. In some embodiments, the predetermined time difference is set so that vehicles to be parked that have entered earlier do not hinder a vehicle of interest from being parked.

Further, the parking position determination unit 21 determines the leaving order of the vehicles to be parked that is the reverse of the entering order. The parking position determination unit 21 determines expected leaving times of the vehicles to be parked so that a lower-numbered vehicle in the leaving order is assigned an earlier expected leaving time. In some embodiments, for example, the parking position determination unit 21 determines the expected leaving times of the vehicles to be parked so that leaving is started a predetermined time after the end time of the event held at the facility or venue related to the parking lot. In some embodiments, the parking position determination unit 21 determines the expected leaving times of the vehicles to be parked so that the difference between the expected leaving times of two successive vehicles to be parked in the leaving order is a predetermined time difference.

When condition 1 is applied, upon determining the parking positions and the expected entering times of the vehicles to be parked, the parking position determination unit 21 passes information indicating the parking positions and the expected entering time of the vehicles to be parked to the notification processing unit 22. The parking position determination unit 21 may further pass information indicating the expected leaving times of the vehicles to be parked to the notification processing unit 22.

When condition 2 is applied, every time a parking request signal is received, i.e., every time a vehicle to be parked reaches the parking area, the parking position determination unit 21 identifies the vehicle to be parked, which has transmitted the parking request signal, by referring to identifying information of the vehicle included in the received parking request signal. The identifying information of the vehicle is similar to that in the case where condition 1 is applied.

The parking position determination unit 21 reads outline information corresponding to the identifying information of the vehicle included in the received parking request signal, from the storage device 12. In addition, the parking position determination unit 21 reads information indicating the shape and size of a parking area of a parking lot managed by the server 3 from the storage device 12. The parking position determination unit 21 then determines a parking position of the vehicle to be parked, in accordance with a bottom-left algorithm by referring to the shape and size of the parking area, the parking position and outline information of each vehicle parked in the parking area, and outline information of the vehicle to be parked. To this end, the parking position determination unit 21 may use any of various bottom-left algorithms. This enables the parking position determination unit 21 to determine a parking position of the vehicle to be parked without wasting space in the parking area, taking account of the parking positions of the parked vehicles. In some embodiments, when condition 2 is applied, the parking position determination unit 21 also determines the parking position of each vehicle to be parked so that a space necessary for occupants to get on and off can be left between adjacent parked vehicles. To achieve this, the parking position determination unit 21 expands the outer shape of the vehicle to be parked, which is specified by outline information, by a predetermined offset, and uses the expanded shape at application of the bottom-left algorithm. In the case where occupants of each vehicle to be parked get off near the entrance of the parking lot and where each vehicle to be parked is autonomously driven in the parking area, the parking position determination unit 21 may determine the parking position of each vehicle to be parked so as to reduce the distance between adjacent parked vehicles. Thus, in some embodiments, the parking position determination unit 21 sets the predetermined offset at a smaller value.

When condition 2 is applied, the leaving order of vehicles to be parked also is the reverse of the order in which the vehicles to be parked enter the parking area.

When condition 2 is applied, the parking position determination unit 21 passes information indicating the parking position of the vehicle to be parked to the notification processing unit 22 every time the parking position of the vehicle to be parked is determined.

The notification processing unit 22 generates, for each vehicle to be parked, a parking position notification signal including information indicating the parking position of the vehicle to be parked. The notification processing unit 22 notifies each vehicle to be parked of the parking position by transmitting the parking position notification signal generated for the vehicle to be parked via the communication interface 11, the communication network 4, and the wireless base station 5.

In particular, when condition 1 above is applied, the notification processing unit 22 includes, for each vehicle to be parked, information indicating the parking position and the expected entering time determined for the vehicle to be parked, in the parking position notification signal. For each vehicle to be parked, the notification processing unit 22 may further include information indicating the expected leaving time determined for the vehicle to be parked, in the parking position notification signal. When condition 2 above is applied, the notification processing unit 22 includes information indicating the parking position determined for the vehicle to be parked, in the parking position notification signal.

The information indicating the parking position may be information indicating the coordinates of a reference position in a rectangular region indicating the space where the vehicle is to be parked and the size of this region. Alternatively, the information indicating the parking position may be an image representing the parking area on which the outline of a rectangular region indicating the space where the vehicle is to be parked is virtually superposed.

When the ECU of a vehicle to be parked parks the vehicle at a notified parking position based on the position of the vehicle 2 measured by a GPS receiver, the actual parking position may be different from the notified parking position, depending on the accuracy of position determination by the GPS receiver. Thus the notification processing unit 22 may further include information indicating a distinctive feature in the parking area or an area therearound and the position (including the height from the road surface) of the feature in a parking position notification signal. The ECU of a vehicle to be parked can detect the feature, based on an image obtained by a vehicle-mounted camera, and measure the position of the vehicle to be parked exactly, based on the result of detection. To this end, the ECU estimates the positional relationship between the feature and the vehicle to be parked, by referring to the position of the region representing the feature in the image and parameters such as the mounted position, the orientation, and the focal length of the vehicle-mounted camera. Based on the position of the feature and the estimated positional relationship, the ECU can measure the position of the vehicle to be parked. In this way, the vehicle to be parked can reduce the error of the parking position.

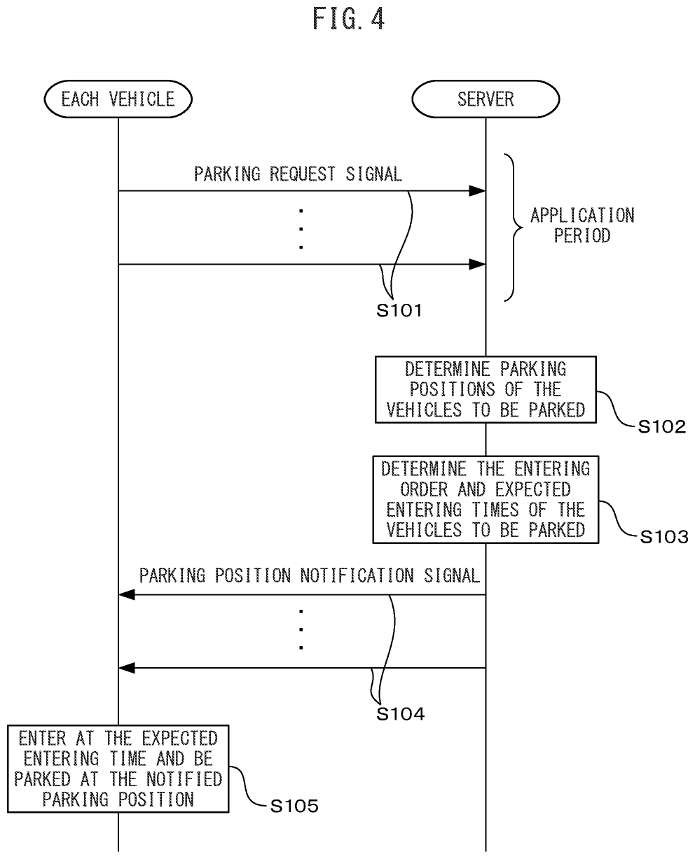

FIG. 4 illustrates the sequence of the parking management process executed between each vehicle to be parked and the server 3 when condition 1 is applied, i.e., when the entering order and the leaving order of vehicles to be parked are fixed.

Each of one or more vehicles that wish to be parked in a parking lot managed by the server 3 transmits a parking request signal including its own identifying information to the server 3 in an application period (step S101). After the application period, the parking position determination unit 21 of the processor 14 of the server 3 determines parking positions of the vehicles to be parked, in accordance with a best-fit algorithm by referring to outline information of each vehicle to be parked and the shape and size of the parking area (step S102). In addition, the parking position determination unit 21 determines the entering order and expected entering times of the vehicles to be parked, based on the parking positions of the vehicles to be parked and the position of the entrance of the parking area (step S103). The notification processing unit 22 of the processor 14 of the server 3 notifies each vehicle to be parked of a parking position notification signal including information indicating the parking position and the expected entering time (step S104). By referring to the expected entering time and the parking position indicated by the notified parking position notification signal, each vehicle to be parked enters the parking area at the expected entering time and is parked at the parking position (step S105). When the parking position notification signal includes an expected leaving time, each vehicle to be parked leaves the parking area at the expected leaving time notified to the vehicle.

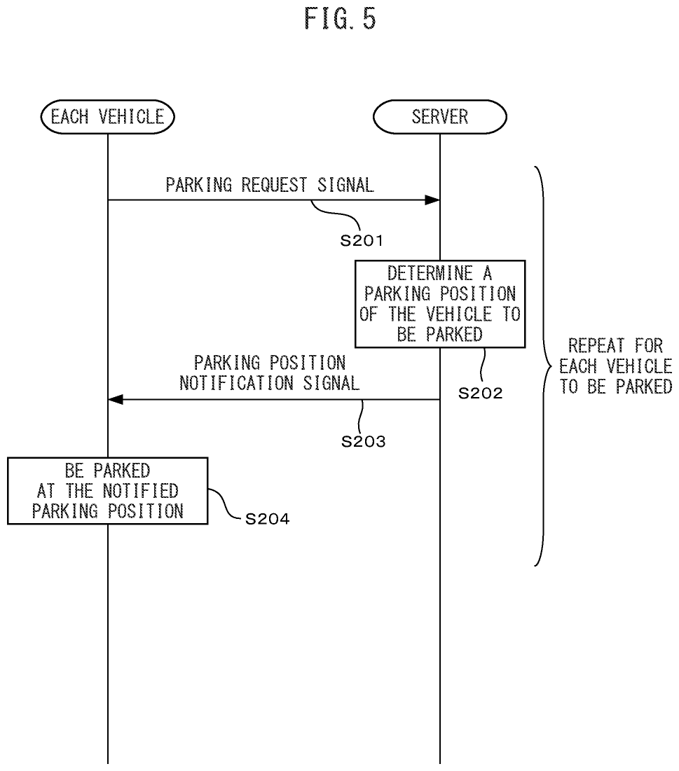

FIG. 5 illustrates the sequence of the parking management process executed between each vehicle to be parked and the server 3 when condition 2 is applied, i.e., when the leaving order of vehicles to be parked is fixed and the entering order of the vehicles is not restricted.

A vehicle that wishes to be parked in a parking lot managed by the server 3 transmits a parking request signal including its own identifying information to the server 3 (step S201). The parking position determination unit 21 of the processor 14 of the server 3 determines a parking position of the vehicle to be parked, in accordance with a bottom-left algorithm by referring to outline information of the vehicle to be parked, the parking positions and outline information of parked vehicles, and the shape and size of the parking area (step S202). The notification processing unit 22 of the processor 14 of the server 3 notifies the vehicle to be parked of a parking position notification signal including information indicating the parking position (step S203). The vehicle is parked at the parking position indicated by the notified parking position notification signal (step S204). The parking management system repeats the processing of steps S201 to S204 every time one of the vehicles 2 tries to be parked in the parking lot managed by the server 3. In this case, each parked vehicle leaves the parking area after leaving of other vehicles nearer the exit of the parking area than the parked vehicle.

As has been described above, the parking management device determines parking positions of vehicles requesting parking in a parking area to be managed, based on the shape and size of the parking area and outline information indicating the shape and size of each vehicle, and notifies each vehicle of the determined parking position. Specifically, the parking management device determines parking positions of the vehicles to be parked, in accordance with a solution to a “rectangle packing problem.” Thus the parking management device can determine parking positions of vehicles without wasting space in the parking area.

According to a modified example, each vehicle 2 may include its own outline information in a parking request signal, and transmit the parking request signal to the server 3. In this case, the server 3 does not need to prestore outline information of each vehicle 2, and only has to temporarily store outline information included in a received parking request signal in the memory 13.

According to another modified example, the parking position determination unit 21 may determine the parking positions of vehicles to be parked, taking account of a space where each vehicle to be parked turns and passes to enter or leave the parking area. In this case, the leaving order of the vehicles to be parked is not restricted, and the vehicles to be parked can leave the parking area in arbitrary order after parking.

In this case, for example, the parking position determination unit 21 divides the parking area into multiple divisions separated by a space for vehicles to turn and pass. For each division, the space for passage is set so that a vehicle parked in the division can pass from the division to the entrance of the parking area. In addition, the shape, size, and position in the parking area of each division may be preset and prestored in the storage device 12. In some embodiments, the shape and size of each division is set so that at least a predetermined number of vehicles of a predetermined size can be parked in a single division. The shapes and sizes of the divisions may be the same, or the size and shape of a division may differ from those of another division.

The parking position determination unit 21 assigns each vehicle to be parked one of the divisions. Specifically, the parking position determination unit 21 assigns a division farther from the entrance of the parking area to a vehicle to be parked from which the server 3 has received a parking request signal earlier. When the number of vehicles to be parked that are assigned a division reaches a predetermined assignment number, the parking position determination unit 21 assigns the next division in descending order of distance from the entrance, to a vehicle to be parked from which the next parking request signal is received. Alternatively, every time the server 3 receives a parking request signal, the parking position determination unit 21 may assign one of the divisions in turn to a vehicle to be parked corresponding to the received parking request signal. The parking position determination unit 21 then stops assigning a new vehicle to be parked a division assigned to a predetermined assignment number of vehicles to be parked. The predetermined assignment number is set at the quotient of the area of a division divided by a standard value of the area of a parking space per vehicle or the difference between the quotient and a predetermined offset value. For each division, the parking position determination unit 21 then determines parking positions of vehicles to be parked that are assigned the division, by applying a solution to a rectangle packing problem, such as a best-fit algorithm or a bottom-left algorithm, based on the shape and size of the division and outline information of the vehicles to be parked. In this way, restrictions on the leaving order are removed, and vehicles to be parked can leave the parking area in any order after parking in the parking area.

The parking position determination unit 21 may divide the parking area into multiple divisions so that a division emptied after leaving of parked vehicles serves as a space for vehicles parked in an adjacent division to turn and pass. In other words, the parking position determination unit 21 divides the parking area into multiple divisions so that the space for turning and passing of at least one division overlaps another division. In this case, the parking position determination unit 21 sets the leaving order on a division-by-division basis. Specifically, the parking position determination unit 21 determines the leaving order of the divisions so that vehicles in a division nearer the entrance of the parking area leave earlier. Then, for each division, the parking position determination unit 21 may set expected leaving times of vehicles at parking positions included in the division, based on the place of the division in the leaving order. More specifically, the parking position determination unit 21 assigns an earlier expected leaving time to a vehicle to be parked corresponding to a parking position included in a lower-numbered division in the leaving order. The parking position determination unit 21 determines the expected leaving times of vehicles at respective parking positions so that the difference between expected leaving times of two successive divisions in the leaving order is equal to the time required for leaving of all the vehicles parked in the lower-numbered one of the two divisions in the leaving order. Further, the notification processing unit 22 includes, for each vehicle to be parked, the expected leaving time corresponding to a division including the parking position of the vehicle, in a parking position notification signal to the vehicle to be parked. In this way, the parking management device can avoid wasting space in the parking area and make the leaving order of vehicles parked in the parking area be flexible to a certain extent.

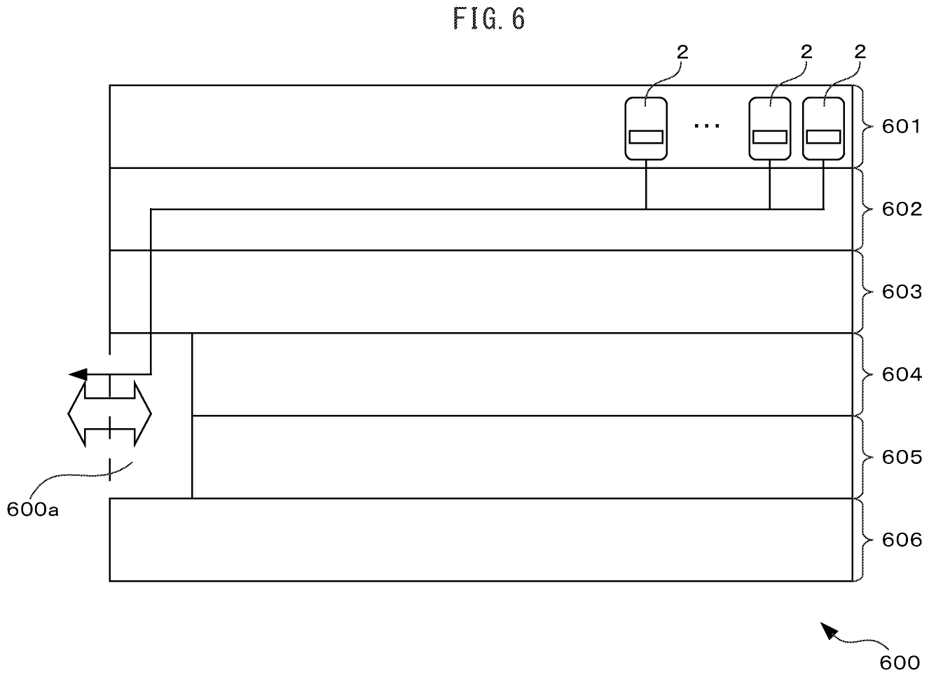

FIG. 6 is a schematic diagram for explaining determination of parking positions of vehicles according to this modified example. In the example illustrated in FIG. 6, a parking area 600 is divided into six divisions 601 to 606. For each of the divisions 601 to 606, the parking positions of vehicles to be parked that are assigned the division are determined in accordance with a best-fit algorithm or a bottom-left algorithm. Of the divisions 601 to 606, the division 602 is also used as a space for vehicles parked in the division 601 to turn and pass. Similarly, the division 603 is also used as a space for vehicles parked in the divisions 601 and 602 to turn and pass. The division 604 is also used as a space for vehicles parked in the divisions 601 to 603 to turn and pass. The division 605 is also used as a space for vehicles parked in the division 606 to turn and pass. Thus, as illustrated in the figure, vehicles 2 parked in the division 601 can leave through an entrance 600a in any order when no vehicle is parked in the division 602. Similarly, vehicles 2 parked in the division 602 can leave through the entrance 600a in any order when no vehicle is parked in the division 603. The same hold true for vehicles parked in the divisions 603 and 606. In this way, the leaving order of vehicles is made to be flexible on a division-by-division basis, according to this modified example.

In the above-described embodiment or modified examples, the parking position determination unit 21 may apply another solution to a rectangle packing problem other than a best-fit algorithm and a bottom-left algorithm to determine the parking positions of vehicles to be parked.

The computer program for causing a computer to achieve the functions of the units included in the processor of the parking management device according to the embodiment or modified examples may be provided in a form recorded on a computer-readable storage medium. The computer-readable storage medium may be, for example, a magnetic medium, an optical medium, or a semiconductor memory.

As described above, those skilled in the art may make various modifications according to embodiments within the scope of the present disclosure.

What is claimed is:

1. A parking management device, comprising:
a memory configured to store a shape and size of a predetermined parking area; and
a processor configured to:
determine parking positions of a plurality of vehicles requesting parking in the parking area, based on the shape and size of the parking area and outline information indicating a shape and size of each of the vehicles, and
notify each of the vehicles of a parking position determined for the vehicle via a communication interface.

2. The parking management device according to claim 1, wherein the processor determines a parking position and an expected time of entering the parking area for each of the vehicles in accordance with a best-fit algorithm after receiving requests for parking from the vehicles, and notifies each of the vehicles of the expected time of entering and the parking position of the vehicle via the communication interface.

3. The parking management device according to claim 1, wherein every time one of the vehicles arrives at the parking area, the processor determines a parking position of the arrived vehicle in accordance with a bottom-left algorithm.

4. The parking management device according to claim 2, wherein the processor is further configured to
divide the parking area into a plurality of divisions,
assign each of the vehicles one of the divisions, and
determine, for each of the divisions, parking positions of one or more vehicles assigned the division among the plurality of vehicles, based on the outline information of the one or more vehicles and a shape and size of the division.

5. The parking management device according to claim 4, wherein the processor divides the parking area into the divisions so as to provide each of the divisions with a passage space that enables the one or more vehicles to pass from the division to an entrance of the parking area.

6. The parking management device according to claim 5, wherein the processor sets the passage space so that the passage space of at least one of the divisions overlaps another of the divisions.

7. A parking management method, comprising:
determining parking positions of a plurality of vehicles requesting parking in a predetermined parking area, based on a shape and size of the parking area and outline information indicating a shape and size of each of the vehicles; and
notifying each of the vehicles of a parking position determined for the vehicle via a communication interface.

8. A non-transitory recording medium that stores a parking management computer program, the computer program causing a computer to execute a process comprising:
determining parking positions of a plurality of vehicles requesting parking in a predetermined parking area, based on a shape and size of the parking area and outline information indicating a shape and size of each of the vehicles; and
notifying each of the vehicles of a parking position determined for the vehicle via a communication interface.
